(19) United States
(12) Patent Application Publication
(10) Pub. No.: US 2009/0304762 A1
(43) Pub. Date: Dec. 10, 2009

(54) Antimicrobial thermoplastic molding composition

(75) Inventor: Xiangyang Li, Seven Fields, PA (US)

Correspondence Address: BAYER MATERIAL SCIENCE LLC, 100 BAYER ROAD, PITTSBURGH, PA, 15205, US

(73) Assignee: Bayer MaterialScience LLC

(21) Appl. No.: 12/156,897

(22) Filed: Jun. 5, 2008

(51) Int. Cl. A01N 25/08; A01N 59/06; A01N 59/16; A01P 1/00

(52) U.S. Cl. 424/409; 424/618; 424/684; 424/641

(57) ABSTRACT

A thermoplastic composition having antimicrobial and good impact properties is disclosed. The composition comprises (i) (co)polycarbonate, (ii) (co)polyester, (iii) grafted elastomeric (co)polymer and an amount of an antimicrobial agent. The antimicrobial agent that contains zeolite, metal oxide and hydrotalcite is present in an amount sufficient to impart to the composition antimicrobial efficacy.

### FIELD OF THE INVENTION

The invention concerns a thermoplastic molding composition and more particularly a polycarbonate composition having antimicrobial properties.

### TECHNICAL BACKGROUND OF THE INVENTION

Inorganic, silver containing antimicrobial compounds are known. Zeolite as a component of antibiotic resins is also known. Relevant disclosures were made in U.S. Pat. Nos. 4,775,585; 4,938,955 4,938,958; 4,911,899 and 4,906,464. The antimicrobial polymer composition disclosed in U.S. Pat. No. 5,827,524 included a crystalline silicon dioxide containing silver ions and one or two optional metal ions selected from the group consisting of zinc and copper as antimicrobial composition. Polymers including the antibiotic zeolites have been used to make refrigerators, dish washers, rice cookers, plastic film, plastic chopping boards, vacuum bottles, plastic pails, and garbage containers. Additional examples of the use of antibiotic zeolite are noted to have been disclosed in U.S. Pat. Nos. 5,714,445; 5,697,203; 5,562,872; 5,180,585; 5,714,430; and 5,102,401. U.S. published patent application 20040002557 disclosed a dental composition comprising a silver-containing ceramic having antimicrobial and color stabilizing properties and methods for using the composition. A transparent antimicrobial thermoplastic molding composition has been disclosed in U.S. published patent application 20070148257. The disclosed composition contains aromatic polycarbonate resin and 0.01 to 3.8 of antimicrobial silver containing compound. The composition is suitable for molding articles having good appearance and surface qualities.

### SUMMARY OF THE INVENTION

A thermoplastic molding composition that exhibits antimicrobial properties and good impact properties is disclosed. The composition comprises (i) (co)polycarbonate, (ii) (co)polyesters, (iii) grafted elastomeric (co)polymer and an amount of an antimicrobial agent. The antimicrobial agent contains zeolite, metal oxide and hydrotalcite and is present in an amount sufficient to impart to the composition antimicrobial efficacy.

### DETAILED DESCRIPTION OF THE INVENTION

The inventive antimicrobial composition contains 100 parts by weight of a blend of
(i) aromatic (co)polycarbonate, and
(ii) polyalkylene terephthalate wherein the weight ratio (i)/(ii) is 99/1 to 1/99, and
(iii) to 25 parts per 100 parts by weight of resin blend (pphr) of a grafted elastomeric (co)polymer, and
(iv) an antimicrobial agent in amount sufficient to impart antimicrobial properties to the composition.

In a preferred embodiment the resin blend contains 50 to 99 parts by weight (pbw) of component (i) and 1 to 50 pbw of component (ii), more preferably 50 to 80 pbw of (i) and 50 to 20 pbw of (ii). In further embodiments the grafted elastomeric (co)polymer is present in the composition is an amount 5 to 25, more preferably 5 to 15 pphr. Advantageously, the antimicrobial agent is present in the composition in an amount of 0.1 to 5, preferably 0.1 to 3 more advantageously 0.3 to 1.5 pphr.

### Component (i): (Co)Polycarbonate

The term aromatic (co)polycarbonate refers to a member selected from the group consisting of homopolycarbonate, copolycarbonate and polyestercarbonate. (Co)polycarbonate may be prepared by known processes (see for instance Schnell's “Chemistry and Physics of Polycarbonates”, Interscience Publishers, 1964) and are widely available in commerce, for instance from Bayer MaterialScience under the trademark Makrolon®.

Aromatic polycarbonates may be prepared by the known melt process or the phase boundary process.

Aromatic dihydroxy compounds suitable for the preparation of aromatic polycarbonates and/or aromatic polyester carbonates conform to formula (I)

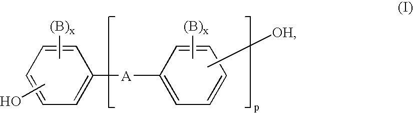

wherein
A represents a single bond, C₁- to C₅-alkylene, C₂- to C₅-alkylidene, C₅- to C₆-cycloalkylidene, —O—, —SO—, —CO—, —S—, —SO₂—, C₆- to C₁₂-arylene, to which there may be condensed other aromatic rings optionally containing hetero atoms, or a radical conforming to formula (II) or (III)

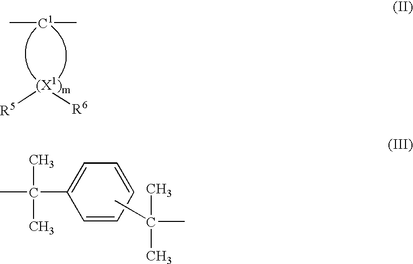

The substituents B independently one of the others denote C₁- to C₁₂-alkyl, preferably methyl,
x independently one of the others denote 0, 1 or 2,
p represents 1 or 0, and
R⁵ and R⁶ are selected individually for each X¹ and each independently of the other denote hydrogen or C₁- to C₆-alkyl, preferably hydrogen, methyl or ethyl,
X¹ represents carbon, and m represents an integer of 4 to 7, preferably 4 or 5, with the proviso that on at least one atom X¹, R⁵ and R⁶ are both alkyl groups.

Preferred aromatic dihydroxy compounds are hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl)ethers, bis-(hydroxyphenyl) sulfoxides, bis-(hydroxyphenyl) ketones, bis-(hydroxyphenyl)-sulfones and α,α-bis-(hydroxyphenyl)-diisopropyl-benzenes. Particularly preferred aromatic dihydroxy compounds are 4,4′ dihydroxydiphenyl, bisphenol A, 2,4-bis-(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenyl sulfide, 4,4′-dihydroxydiphenyl-sulfone. Special preference is given to 2,2-bis-(4-hydroxyphenyl)-propane (bisphenol A). These compounds may be used individually or in the form of any desired mixtures.

Chain terminators suitable for the preparation of thermoplastic aromatic polycarbonates include phenol, p-chlorophenol, p-tert.-butylphenol, as well as long-chained alkylphenols, such as 4-(1,3-tetra-methylbutyl)-phenol or monoalkylphenols or dialkylphenols having a total of from 8 to 20 carbon atoms in the alkyl substituents, such as 3,5-di-tert.-butylphenol, p-isooctylphenol, p-tert.-octylphenol, p-dodecylphenol and 2-(3,5-dimethylheptyl)-phenol and 4-(3,5-dimethylheptyl)-phenol. The amount of chain terminators to be used is generally 0.5 to 10% based on the total molar amount of the aromatic dihydroxy compounds used. The (co)polycarbonates may be branched in a known manner, preferably by the incorporation of 0.05 to 2.0%, based on the sum of the molar amount of the aromatic dihydroxy compounds use, of compounds having a functionality of three or more, for example compounds having three or more phenolic groups.

Aromatic polyestercarbonates are known. Suitable such resins are disclosed in U.S. Pat. Nos. 4,334,053; 6,566,428 and in CA 1173998, all incorporated herein by reference. Aromatic dicarboxylic acid dihalides for the preparation of aromatic polyester carbonates include diacid dichlorides of isophthalic acid, terephthalic acid, diphenyl ether 4,4′-dicarboxylic acid and naphthalene-2,6-dicarboxylic acid. Particularly preferred are mixtures of diacid dichlorides of isophthalic acid and terephthalic acid in a ratio of from 1:20 to 20:1. Branching agents may also be used in the preparation of suitable polyestercarbonates, for example, carboxylic acid chlorides having a functionality of three or more, such as trimesic acid trichloride, cyanuric acid trichloride, 3,3′-,4,4′-benzophenone-tetracarboxylic acid tetrachloride, 1,4,5,8-naphthalenetetracarboxylic acid tetrachloride or pyromellitic acid tetrachloride, in amounts of 0.01 to 1.0 mol. % (based on dicarboxylic acid dichlorides used), or phenols having a functionality of three or more, such as phloroglucinol, 4,6-dimethyl-2,4,6-tri-(4-hydroxyphenyl)-heptene-2,4,4-dimethyl-2,4,6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenylmethane, 2,2-bis[4,4-bis(4-hydroxyphenyl)-cyclohexyl]-propane, 2,4-bis(4-hydroxyphenyl-isopropyl)-phenol, tetra-(4-hydroxyphenyl)-methane, 2,6-bis(2-hydroxy-5-methyl-benzyl)-4-methylphenol, 2-(4-hydroxyphenyl)-2-(2,4-dihydroxyphenyl)-propane, tetra-(4-[4-hydroxyphenyl-isopropyl]-phenoxy)-methane, 1,4-bis[4,4′-dihydroxy-triphenyl)-methyl]-benzene, in amounts of from 0.01 to 1.0 mol. %, based on diphenols used. Phenolic branching agents can be placed in the reaction vessel with the diphenols, acid chloride branching agents may be introduced together with the acid dichlorides.

The content of carbonate structural units in the thermoplastic aromatic polyester carbonates is preferably up to yet less than 100 mol. %, especially up to 80 mol. %, particularly preferably up to 50 mol. %, based on the sum of ester groups and carbonate groups. Both the esters and the carbonates contained in the aromatic polyestercarbonates may be present in the polycondensation product in the form of blocks or in a randomly distributed manner.

The suitable thermoplastic aromatic (co)polycarbonate has weight-average molecular weight (measured by gel permeation chromatography) of at least 25,000, preferably at least 26,000. Preferably these have maximum weight-average molecular weights of 35,000, more preferably up to 32,000, particularly preferably up to 30,000 g/mol. The thermoplastic aromatic (co)polycarbonate may be used alone or in any desired mixture.

### Component (ii): (Co)Polyesters

The term (co)polyester in the present context refers to a homo-polyester and to copolyester resins. A (co)polyester includes in its molecular structure at least one unit derived from a carboxylic acid, preferably excluding units derived from carbonic acid. These are known resins that may be prepared through condensation or ester interchange polymerization of the diol component with the diacid according to known methods. Examples are esters derived from the condensation of a cyclohexane-dimethanol with an ethylene glycol with a terephthalic acid or with a combination of terephthalic acid and isophthalic acid. Also suitable are polyesters derived from the condensation of a cyclohexanedimethanol and ethylene glycol with a 1,4-cyclohexanedicarboxylic acid. Suitable resins include poly(alkylene dicarboxylates), especially poly(ethylene tere-phthalate) (PET), poly(1,4-butylene terephthalate) (PBT), poly(trimethylene terephthalate) (PTT), poly(ethylene naphthalate) (PEN), poly(butylenes naphthalate) (PBN), poly(cyclohexanedimethanol terephthalate) (PCT), poly(cyclohexanedimethanol-co-ethylene terephthalate) (PETG or PCTG), and poly(1,4-cyclohexanedimethyl-1,4-cyclohexanedicarboxylate) (PCCD).

U.S. Pat. Nos. 2,465,319; 3,953,394 and 3,047,539, all incorporated herein by reference, disclose suitable methods for preparing (co)polyesters. Particularly suitable are polyalkylene terephthalates characterized in their intrinsic viscosity that is at least 0.2 and preferably about at least 0.4 deciliter/gram as measured by the relative viscosity of an 8% solution in orthochlorophenol at about 25° C. The upper limit is not critical but it generally does not exceed about 2.5 deciliters/gram. Especially preferred polyalkylene terephthalates are those with an intrinsic viscosity in the range of 0.4 to 1.3 deciliter/gram.

The alkylene units of the preferred polyalkylene terephthalate contain from 2 to 5, preferably 2 to 4 carbon atoms. Polybutylene terephthalate (prepared from 1,4-butanediol) and polyethylene terephthalate are the preferred polyalkylene tetraphthalates for use in the present invention. Other suitable polyalkylene terephthalates include polypropylene terephthalate, polyisobutylene terephthalate, polypentyl terephthalate, polyisopentyl terephthalate, and polyneopentyl terephthalate. The alkylene units may be straight chains or branched chains.

The polyalkylene terephthalates are reaction products of aromatic dicarboxylic acids or reactive derivatives thereof, such as dimethyl esters or anhydrides, and aliphatic, cycloaliphatic or araliphatic diols, and mixtures of those reaction products. Preferred polyalkylene terephthalates contain at least 80%, preferably at least 90%, based on the dicarboxylic acid component, of terephthalic acid radicals and at least 80%, preferably at least 90%, based on the moles of the diol component, of ethylene glycol and/or 1,4-butanediol radicals.

Also suitable are polyalkylene terephthalates that contain, in addition to terephthalic acid radicals, up to 20 mol. %, preferably up to 10 mol. %, of radicals of other aromatic or cycloaliphatic dicarboxylic acids having from 8 to 14 carbon atoms or aliphatic dicarboxylic acids having from 4 to 12 carbon atoms, such as radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid. Also suitable are polyalkylene terephthalates that contain, in addition to ethylene glycol or 1,4-butanediol radicals, up to 20 mol. %, preferably up to 10 mol. %, of other aliphatic diols having from 3 to 12 carbon atoms or cycloaliphatic diols having from 6 to 21 carbon atoms, for example radicals of 1,3-propanediol, 2-ethyl-1,3-propanediol, neopentyl glycol, 1,5-pentanediol, 1,6-hexanediol, cyclohexane-1,4-dimethanol, 3-ethyl-2,4-pentanediol, 2-methyl-2,4-pentanediol, 2,2,4-trimethyl-1,3-pentanediol, 2-ethyl-1,3-hexanediol, 2,2-diethyl-1,3-propanediol, 2,5-hexanediol, 1,4-di-(β-hydroxyethoxy)-benzene, 2,2-bis-(4-hydroxycyclohexyl)-propane, 2,4-dihydroxy-1,1,3,3-tetramethyl-cyclobutane, 2,2-bis-(4-β-hydroxyethoxy-phenyl)-propane and 2,2-bis-(4-hydroxypropoxyphenyl)-propane (see U.S. Pat. No. 4,176,224, incorporated herein by reference).

The (co)polyester may be branched by the incorporation of relatively small amounts of tri- or tetrahydric alcohols or tri- or tetra-basic carboxylic acids, for example according to U.S. Pat. No. 3,692,744 (incorporated herein by reference). Examples of preferred branching agents are trimesic acid, trimellitic acid, trimethylol-ethane and propane and pentaerythritol. Particular preference is given to polyethylene terephthalates and/or polybutylene terephthalates, with polyethylene terephthalate being especially preferred.

Component (iii): Grafted Elastomeric (Co)Polymer

The grafted rubber useful in the present invention is obtained by graft-polymerizing at least one vinyl monomer, optionally containing an aromatic vinyl monomer to an elastomer.

Preferably, the graft polymer is obtained by graft polymerizing an aromatic vinyl monomer and at least one monomer selected from the group consisting of (meth)acrylonitrile, (meth)acrylates, maleimide monomers and unsaturated dicarboxylic acid anhydride monomers, to an elastomer having a glass transition temperature of not higher than 10° C.

The aromatic vinyl monomers are exemplified by styrene, α-methylstyrene and a halogen-substituted styrene. The (meth)acrylates are exemplified by methyl acrylate, ethyl acrylate, methylmethacrylate and ethyl methacrylate. The maleimide monomers are exemplified by maleimide, N-methylmaleimide, N-ethylmaleimide, N-propylmaleimide, N-hexylmaleimide, N-cyclohexylmaleimide and N-phenylmaleimide. Maleic anhydride is an example of an unsaturated dicarboxylic acid anhydride monomer. These monomers may be used in combination of two or more of them.

Methods for producing the graft polymer are known and are exemplified by bulk polymerization, solution polymerization, suspension polymerization or emulsion polymerization.

The preferred monomers for making the graft polymer of the present invention are styrene and acrylonitrile and methyl methacrylate.

The preferred elastomers for making the graft polymer of the present invention include butadiene elastomer, acrylic elastomer, ethylene-propylene elastomer and silicone elastomer. Examples of the butadiene elastomer include polybutadiene, butadiene-styrene copolymer and butadiene-acrylonitrile copolymer. Examples of acrylic elastomers include homo-polymerized acrylate monomer such as ethyl acrylate, butyl acrylate or 2-ethylhexyl acrylate or copolymerization products of any of the aforementioned acrylates with other copolymerizable monomer.

Other suitable elastomers include ethylene-propylene elastomer preferably such as having ethylene to propylene ratio within a range of from 80:20 to 60:40 and may further contain a copolymerized diene component. Also suitable are silicone elastomers, preferably polyorganosiloxane elastomer having mainly repeating units of dimethylsiloxane. Further suitable is the known composite elastomer that include silicone elastomer component and acrylic elastomer component, or a composite elastomer comprising a butadiene elastomer component and an acrylic elastomer component. There is no particular restriction as to the method for producing an elastomer, and a conventional method such as bulk polymerization, solution polymerization, suspension polymerization or emulsion polymerization may be used. In the present invention, a butadiene based elastomer polymer is preferably employed.

The preferred grafted elastomeric (co)polymer is acrylonitrile-butadiene-styrene (ABS) a known and commercially available material.

### Component (iv): Antimicrobial Agent

The inorganic antimicrobial agent incorporated in inventive composition is a material system that includes zeolite (natural or synthetic) in particulate form, at least one metal oxide and hydrotalcite.

The preferred zeolite is characterized in that the largest dimension of its particles is less than 5 microns. The specific surface area of preferred zeolite particles is at least 150 m²/g and the mole ratio SiO₂/Al₂O₃ in the zeolite composition is preferably less than 14, more preferably less than 11. Suitable materials have been disclosed in U.S. Pat. Nos. 5,009,898; 5,296,238; 5,441,717; 5,405,644; 4,938,958 and 4,911,899, all incorporated herein by reference.

The suitable metal oxide is an oxide of at least one metal selected from the group consisting of silver, copper, zinc, mercury, tin, lead, bismuth, cadmium, chromium and thallium. Preferred metal is selected from the group consisting of silver, gold, copper and zinc, most particularly preferred is at least one of zinc and silver oxides.

Hydrotalcite is a known naturally occurring mineral and may also be synthesized. It is widely known and readily available in commerce.

Hydrotalcite compounds may be represented by formula (I)

[M²⁺₁₋ₓM³⁺ₓ(OH)₂]^{x+}[Aⁿ⁻_{x/n}−mH₂O]^{x-} (I)

where M²⁺ represents a divalent metal ion, preferably Mg²⁺,Mn²⁺,Fe²⁺, Co²⁺; M³⁺ represents a trivalent ion, preferably Al³⁺, Fe³⁺, Cr³⁺; Aⁿ⁻ represents an n-valent anion, particularly monovalent or divalent ions, preferably CO₃²⁻, OH⁻, HPO₄²⁻, or SO₄²⁻, 0<x<0.5; and m is 0≦m<1.

The inventive composition may further include effective amounts of any of the additives known for their function in the context of thermoplastic polycarbonate molding compositions. These include any one or more of lubricants, mold release agents, for example pentaerythritol tetrastearate, nucleating agents, antistatic agents, thermal stabilizers, light stabilizers, antioxidants, hydrolytic stabilizers, fillers and reinforcing agents, colorants or pigments, as well as flame retarding agents, drip suppressants or flame retarding synergists.

The inventive composition may be produced by conventional procedures using known equipment. It may be used to produce moldings of any kind by thermoplastic processes such as injection molding, extrusion and blow molding methods. The Examples which follow are illustrative of the invention.

### EXAMPLES

A composition representative of the invention has been prepared and evaluated and its properties are shown below. Also prepared and evaluated were comparative examples of largely similar compositions that proved inferior.

Heat distortion temperature was determined in accordance with ASTM D 648; Impact strength, notched Izod was determined at the indicated temperatures, using specimens ⅛″ thick. MVR was determined per ASTM D 1238 at 265° C., under 5 kg load.

The color (L*a*b*) was read on ⅛″ color chips according to ASTM E313 in reflection mode with D65 as the illuminant and 10 degree as the view angle.

The exemplified compositions contain identical amounts of the following components:

73.40 pbw bisphenol-A based homopolycarbonate (Makrolon 2608 resin a product of Bayer MaterialScience LLC) characterized in its MVR of 12.5 cm³/10 min at 300° C., 1.2 Kg,
26.60 pbw of polyethylene terephthalate having intrinsic viscosity of 0.57 dl/g,
6.36 pphr ABS, grafted elastomeric polymer containing 75% butadiene rubber.

Each of the compositions (comparative example 1, comparative example 2 and example 1) contained 1.07 pphr of an antimicrobial agent. The control composition contained no antimicrobial agent.

The antimicrobial agent included in Comparative Example 1 was silver zirconium phosphate conforming to the formula Naₓ H_{y}Ag_{z} Zr₂(PO₄)₃ where x+y+z=1.

The antimicrobial agent included in Comparative Example 2 was a mixture of silver-containing borosilicate glass and zinc zeolite. The mixture containing about 1.2% antimicrobial silver ion and 3.6% antimicrobial zinc ion.

(The term “antimicrobial ion” in the present context refers to an ion having antimicrobial efficacy that has been introduced into the zeolite by ion exchange.)

The antimicrobial agent included in the exemplified inventive composition (Example 1) is a material system that contains about 20% silver zinc zeolite, about 70% ZnO and about 10% hydrotalcite (the % being relative to the weight of the system). The hydrotalcite conforms to formula (I) where M²⁺ denotes Mg²⁺, M³⁺ denotes Al³⁺ and Aⁿ⁻ is CO₃²⁻. The agent contains about 0.44% antimicrobial silver ion, and about 1.36% antimicrobial zinc ion. Each of the exemplified compositions further contained 0.21 pphr of tris(2,4-ditert-butylphenyl)phosphite as processing aid having no criticality in the context of the invention. The results of the evaluations are summarized in the table below.

| | Example | | | |
|---|---|---|---|---|
| | | Com- | Com- | Inventive |
| | Control | parative 1 | parative 2 | composition |
| MVR, cm³/10 min. | 20 | 19.6 | 22.4 | 18.9 |
| HDT, ° C. | 107.1 | 106.0 | 104.4 | 107.9 |
| Impact energy, | 12.1 | 6.8 | 4.1 | 12.5 |
| @−20° C. | | | | |
| ft.lbf/in | | | | |
| Impact energy, @23° C. | 16.0 | 16.8 | 14.3 | 15.2 |
| ft.lbf/in | | | | |
| L* | 77.0 | 76.6 | 73.6 | 81.7 |
| a* | −3.4 | −2.9 | −1.8 | −2.0 |
| b* | 4.7 | 6.0 | 8.7 | 5.5 |

The higher impact strength (notched Izod) at low temperature and lighter color of the inventive composition distinguish it over the comparative compositions that contain identical amount of a different antimicrobial agent.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A thermoplastic composition having antimicrobial properties comprising 100 parts by weight of a resin blend of component (i) (co)polycarbonate and component (ii) (co)polyester wherein the weight ratio (i)/(ii) is 99/1 to 1/99, and 1 to 25 parts per 100 parts by weight of resin blend of (iii) a grafted elastomeric (co)polymer and (iv) an amount of antimicrobial agent containing zeolite in particulate form, hydrotalcite and at least one oxide of a metal selected from the group consisting of silver, copper, zinc, mercury, tin, lead, bismuth, cadmium, chromium and thallium, said amount sufficient to impart antimicrobial efficacy to said composition.

2. The composition of claim 1 wherein the resin blend contains 50 to 99 pbw of component (i) and 1 to 50 pbw of component (ii).

3. The composition of claim 1 wherein the resin blend contains 50 to 80 pbw of component (i) and 50 to 20 pbw of component (ii).

4. The composition of claim 1 wherein the grafted elastomeric (co)polymer is present in the composition is an amount of 5 to 25 pphr.

5. The composition of claim 1 wherein the grafted elastomeric (co)polymer is present in the composition is an amount of 5 to 15 pphr.

6. The composition of claim 1 wherein the antimicrobial agent is present in the composition in an amount of 0.1 to 5 pphr.

7. The composition of claim 1 wherein the antimicrobial agent is present in the composition in an amount of 0.1 to 3 pphr.

8. The composition of claim 1 wherein the antimicrobial agent is present in the composition in an amount of 0.3 to 1.5 pphr.

9. The composition of claim 1 wherein the antimicrobial agent is a material system that contains 15 to 25% zeolite, 65 to 75% metal oxide and 8 to 12% hydrotalcite, the % all occurrences being relative to the weight of the system.

10. The composition of claim 9 wherein the zeolite has weight average particle size of less than 5 microns.

11. The composition of claim 10 wherein the zeolite is silver zinc zeolite.

12. The composition of claim 1 wherein the antimicrobial agent is a material system that contains 20% silver zinc zeolite, 70% ZnO and 10% hydrotalcite.

13. The composition of claim 1 wherein said metal is at least one metal selected from the group consisting of silver, gold, copper and zinc.

14. The composition of claim 1 wherein said metal is at least one metal selected from the group consisting of zinc and silver.
